(19) United States
(12) Patent Application Publication
(10) Pub. No.: US 2018/0057230 A1
(43) Pub. Date: Mar. 1, 2018

(54) DISSOLVABLE AND EDIBLE PODS

(71) Applicant: Joseph Johnson, Williamston, MI (US)

(72) Inventor: Joseph Johnson, Williamston, MI (US)

(21) Appl. No.: 15/686,648

(22) Filed: Aug. 25, 2017

Related U.S. Application Data
(60) Provisional application No. 62/379,293, filed on Aug. 25, 2016.
(60) Provisional application No. 62/426,838, filed on Nov. 28, 2016.

(51) Int. Cl. B65D 65/46; A23L 2/39; A23L 2/66; B65D 81/32; B65D 85/808; B65B 11/50; B65B 51/10; B65B 31/00; B65B 29/02; B65D 75/30; B65D 75/52

(52) U.S. Cl. CPC B65D 65/463; A23L 2/39; A23L 2/66; B65D 81/32; B65D 85/808; A23V 2002/00; B65B 51/10; B65B 31/00; B65B 29/028; B65D 75/30; B65D 75/52; B65B 11/50

(57) ABSTRACT

An edible and dissolvable pod containing a powder enclosed by a film. The pod is an edible and dissolvable pod configured to dissolve in water or other liquids. The pod includes a dissolvable film of food grade ingredients that dissolves quickly in hot or cold water. When the film from the pod dissolves in the water, then the supplement is free to mix with the water to create a nutritional beverage designed for post workouts. The pod is formed with a lower panel forming a cavity for receiving the powder and covered by an upper panel. The powder defines a pH sufficient to prevent degradation of the film.

### CROSS REFERENCE TO RELATED APPLICATION

Priority is claimed to U.S. Provisional Application No. 62/379,293 filed Aug. 25, 2016, which is incorporated herein by reference in its entirety. Priority is also claimed to U.S. Provisional Application No. 62/426,838 filed Nov. 28, 2016, which is also incorporated herein by reference in its entirety.

### TECHNICAL FIELD

The present specification generally relates to edible and dissolvable pods provided with desirable substances such as powders intended for human consumption.

### BACKGROUND

Nutritional supplements, particularly protein powders, are frequently consumed as post workout beverages. However, mixing these supplements into a beverage has drawbacks, especially while away from home. Some major problems include the hassle of carrying around tubs of protein, pre-workout or other nutritional supplements, as well as struggling with the mess and delay of consuming protein and other supplements due to the time and effort that it takes to scoop it from the protein tub into the bottle.

Containers and tubs of nutritional supplements take up a lot of room in areas such as cars, gym bags and lockers. Scooping servings of protein is usually done in the car or locker room and often results in a mess, leaving a powdery layer of residue over a user's gym bag, clothes and/or car.

Because of the frequent mess caused, users frequently wait until they are home to consume their protein. However, studies clearly show that protein is most effective if taken within thirty minutes of activity.

Accordingly, a need exists for alternative means to transport and deliver supplements when used with a water based beverage.

### SUMMARY

The present disclosure relates to an edible and dissolvable pod having an edible and dissolvable loose powder enclosed by an edible and dissolvable film. In an example, an edible and dissolvable pod is provided that includes an edible and dissolvable substance provided in a loose powder form; and an edible and dissolvable enclosure fully enclosing the edible and dissolvable substance. The enclosure includes (i) a lower panel forming a receiving cavity defining a depth Z, wherein the edible and dissolvable substance is provided in the receiving cavity; (ii) an upper panel positioned over the substance provided in the receiving cavity of the lower panel, the upper panel defining a height H; and (iii) an outer seam forming a seal between the upper and lower panel. The edible and dissolvable substance is provided in a predetermined quantity sufficient to dissolve in a predetermined volume of liquid. The substance defines a pH range sufficient to prevent degradation of the film. The depth Z of the lower panel is greater than height H of the upper panel.

In another example, the enclosure defines a rectangular cross section and the outer seam forms a perimeter surrounding the enclosure. The edible and dissolvable substance can be any desired substance including a protein powder. In yet a further example, the protein powder includes at least 20 grams of protein. The predetermined quantity of edible and dissolvable substance can be provided in a serving having a mass of about 10 grams to 50 grams. In another example the predetermined quantity of edible and dissolvable substance is provided in a serving size having a mass of about 20 grams to 30 grams. In yet another example, the protein powder includes a flavoring agent. The protein powder can include any suitable protein including whey protein.

The present disclosure provides for an edible and dissolvable pod wherein the film includes a polymer such as a food grade polyvinyl alcohol. The film can define a thickness from 1 to 3 millimeters. The film can include a printed design on at least one of the upper and lower panel. The edible and dissolvable pod can further dissolve in the predetermined volume of liquid that is between 8 ounces and 20 ounces and the pod can be formed to dissolve in hot or cold liquid in less than 10 seconds. In one form of the present disclosure, the depth Z is greater than twice the length of height H.

The present disclosure further provides for an edible and dissolvable pod including a plurality of chambers connected to adjacent chambers via a sealed seam and physically separated with respect to a substance provided in the chamber. In one example, the pod further includes a first chamber and at least a second chamber. A second edible and dissolvable substance is provided in the second chamber. The second substance can be different from a substance in the first chamber. In one example, the substance in the first chamber is a protein powder and the second substance is a flavoring agent provided in powder form and suitable for mixing with the protein powder when dissolved in a liquid.

The present disclosure still further provides for an edible and dissolvable pod wherein the substance defines a pH range from about 4 to 10. In another example, the substance defines a pH range from about 5.5 to 8.5. In even still a further example, the powder provided in the enclosure defines a Hausner ratio of between 1-1.25. In one form, the protein powder can include 20 grams of protein and have a calorie content of about 90 calories, and wherein the pod is operable to fully dissolve in a liquid having a volume of 8 oz to 20 oz.

The present disclosure provides for a variety pack of edible and dissolvable pods having a plurality of individual pods. Each pod is sealed off with respect to other pods in the pack and wherein at least two of the pods have different substances.

The present disclosure provides for a method of making a pod including the steps of: (a) providing an edible and dissolvable film as a lower panel into a receiving cavity; (b) filling the cavity with a powder substance that is edible and dissolvable; (c) placing a dissolvable and edible upper panel film over the powder provided in the cavity; (d) heat sealing the upper panel to the lower panel along a peripheral seam; (e) applying a misting operable to generate air release holes in the upper panel thereby releasing air; and (f) cooling the pod to form an airtight seal enclosure formed by the upper and lower panels and the seam.

The present disclosure further provides for an edible and dissolvable pod system including: (a) a first pod having an edible and dissolvable substance provided in a loose powder form fully enclosed by an edible and dissolvable enclosure film having a lower panel forming a receiving cavity defining a depth Z, wherein the edible and dissolvable substance is provided in the receiving cavity, an upper panel positioned over the substance provided in the receiving cavity of the lower panel, the upper panel defining a height H, and an outer seam forming a seal between the upper and lower panel; and (b) a second pod having an edible and dissolvable flavoring agent enclosed in an edible and dissolvable film, the second pod defining a mass smaller than a mass of the first pod. The flavoring agent is selected to compliment the substance of the first pod. The first and second pod are provided in predetermined quantities sufficient to dissolve in a predetermined volume of liquid together. The depth Z of the lower panel is greater than height H of the upper panel. In yet a further example, the present disclosure provides for a variety pack of first pods and second pods, wherein a plurality of different flavored second pods are provided and each of the first and second pods is sealed off with respect to other pods in the pack.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an edible and dissolvable pod and corresponding water bottle in perspective form according to the present disclosure;

FIG. 2 depicts a depicts an edible and dissolvable pod according to the present disclosure;

FIG. 3 depicts an example of the pod being dropped into the water bottle of FIG. 1;

FIG. 4 depicts a top of the pod in the water of FIG. 3;

FIG. 5 depicts the powder post shaking after the edible and dissolvable film has been dissolved according to the present disclosure;

FIG. 6 depicts a further embodiment of a dissolvable pod and corresponding water bottle having a tube shaped configuration allowing for insertion into a standard water bottle according to the present disclosure;

FIG. 7 depicts a perspective view of the tube shaped pod of FIG. 6 according to the present disclosure;

FIG. 8A depicts an end view of an embodiment of the tube shaped pod of FIG. 7 having a formed seam according to the present disclosure;

FIG. 8B depicts an end view of another embodiment of the tube shaped supplement pod of FIG. 7 without the formed seams according to the present disclosure;

FIG. 9 illustrates a dual-chambered edible pod embodiment according to the present disclosure;

FIG. 10 illustrates a further embodiment of the present disclosure having a plurality of sealed-off pod chambers;

FIG. 11 illustrates a cross section view of an example edible pod having sealed panels and a receiving cavity;

FIG. 12 depicts a flow diagram for a process of making an edible pod according to the present disclosure;

FIG. 13 illustrates a further example of an edible and dissolvable pod system including a first pod of a substance and a complimentary second flavoring pod;

FIG. 14 illustrates an example variety pack having the pod system of FIG. 13 with a variety of flavor pods; and

FIGS. 15-17 depict charts illustrating various combinations of nutritional specifications of a powder which can be provided within the pods of the present disclosure.

### DETAILED DESCRIPTION

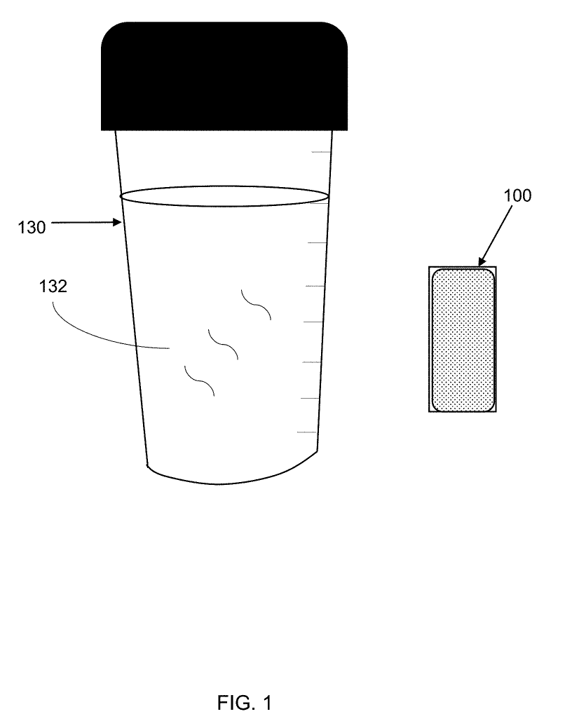

FIG. 1 generally depicts an edible and dissolvable pod containing an edible substance such as a powder. The pod is configured to dissolve in water and/or other liquids. The pod includes a dissolvable film formed of food grade ingredients that dissolve quickly in hot or cold water. In an example, single servings of supplements, such as protein powder, are wrapped in the film to make the pod. When the film from the pod dissolves in the water, the supplement is free to mix with the water to create a flavored and/or nutritional beverage, for example a protein drink designed for post workouts. The term “edible” should be understood to mean any substance that is fit to be eaten, safe to eat, and/or fit for human consumption.

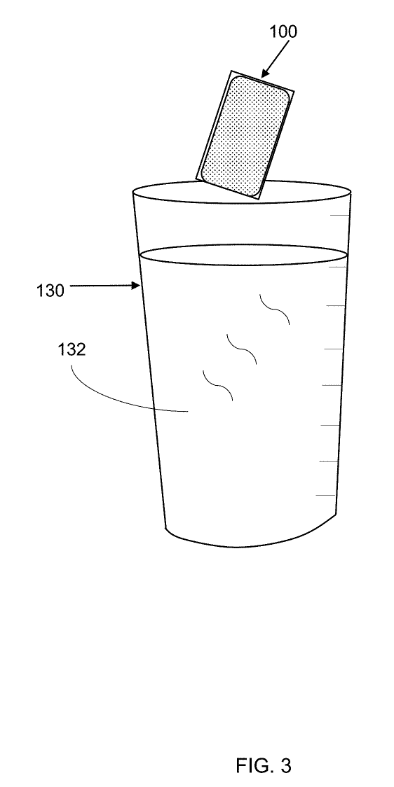

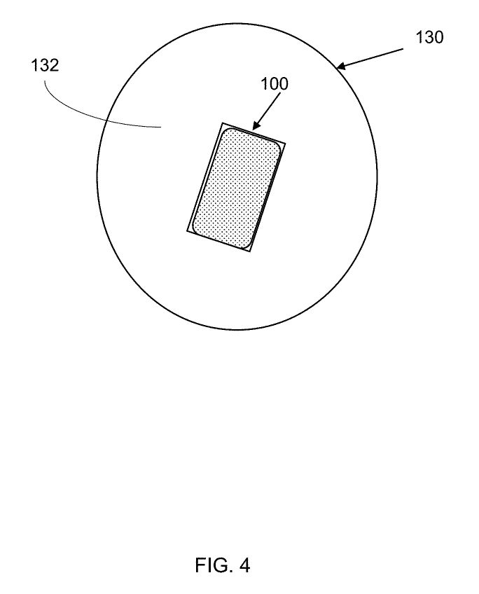

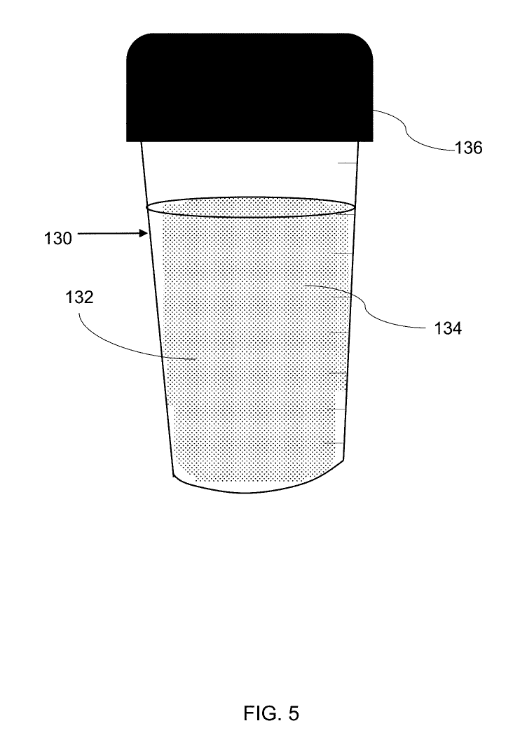

Referring to FIGS. 1-5, an example embodiment of an edible and dissolvable pod 100 is shown. The pod 100 includes a first panel 102 and a second panel 104 positioned opposite the first panel. In one form, the first panel 102 is sealed directly to the second panel 104 forming an interior cavity for receiving a powder. In other embodiments, the panels 102, 104 are formed continuous with respect to each other and then folded at a seam 108 such that a desired substance, such as protein powder or the like, can be placed therebetween in a cavity enclosed by the panels. The panels are formed of an edible film forming an enclosure for containing the desired substance. In this example, the panels 102, 104 are sealed by seams at locations 106, 110, 112 and optionally at 108. In this example, the seams 106, 110, 112, 108 define a plurality of corners 114, 116, 118, 120 thus providing a generally rectangular appearance and/or cross section. Other geometric configurations are contemplated and are within the scope of the present disclosure, such as square, circular, triangular, among others.

In an example, a water bottle 130 is shown. It is within the scope of the present disclosure to consider other containers having a water based or drinkable liquid 132 as illustrated. During use, the pod 100 is placed within the water bottle 130 and into the liquid 132. The liquid 132 is operable to dissolve the edible film enclosure formed by the first panel 102 and the second panel 104. The first panel 102 and the second panel 104 both include of a dissolvable film made of food grade ingredients designed to dissolve quickly in a hot or cold liquid. Further details of the dissolvable and edible film are discussed and described hereinbelow.

In one form of use, a user will place the edible pod 100 in the water bottle 130 containing the water based liquid 132. The user may then seal the water bottle 130 by way of a lid and shake the water bottle (to enhance and/or accelerate mixing/dissolving) containing the pod 100 until the dissolvable film of the first panel 102 and the second panel 104 is dissolved. Upon dissolving of the first panel 102 and the second panel 104, the protein powder 122 is released into the water based liquid 132. The protein powder 122 can then mix with the water based liquid 132 to form a nutritional supplement beverage for consumption. The protein powder 122 does not contact and begin mixing with the liquid 132 until the film begins dissolving. The film is made to completely dissolve in the liquid.

In this example, a protein powder 122, or other nutritional supplement, is enclosed within an enclosure (i.e., pod) formed between the panels 102, 104. The protein powder 122 is designed to be released upon dissolving of the first panel 102 and the second panel 104. As soon as the edible film of the panels 102, 104 begins dissolving, the powder 122 begins mixing with the receiving liquid.

The present specification further includes the method of creating a nutritional beverage using the pod 100. As illustrated in FIGS. 1-5, a water bottle (or shaker bottle) 130 is illustrated containing a water based liquid 132. In this example, the water based liquid 132 is water, however, other liquids are contemplated and within the scope of the present disclosure as such as juice, energy drinks, carbonated beverages, milk and milk substitutes, among others and suitable to dissolve in various temperatures of the liquid from cold to hot. In this example, a user then removes a lid 136 to place the supplement pod 100 within the water 132. The lid 136 is then placed back over bottle 134 and sealed to prevent undesired spilling followed by vigorously shaking the bottle 130 so as to facilitate dissolving of the film of the first panel 102 and the second panel 104 and induce mixing of the powder 122 with the water 132. Once the film is dissolved, the protein powder 122 is allowed to mix with the water 132 so as to create a beverage for consumption. The resultant beverage can be effective as a pre-, post-, or in-workout nutritional or supplement beverage.

It should be noted that the method is not merely limited to shaking as a means to facilitate mixing of the liquid and nutritional supplement. The supplement pod may be used in a liquid with a blender, shaker ball, specialty container and/or stirred to incorporate the supplement powder into the liquid.

In other embodiments, the pod may define various shapes such as a tube, block, cube, sphere or any other suitable shape which encourages the powder mixing with the liquid upon dissolving of the enclosing film. The panels 102, 104 may have various apertures or have various configurations so as to form an enclosure configured to hold the powder 122. The enclosure formed by the film may be any enclosure of sufficient volume to hold the powder 122 and is not limited to any specific shape or configuration.

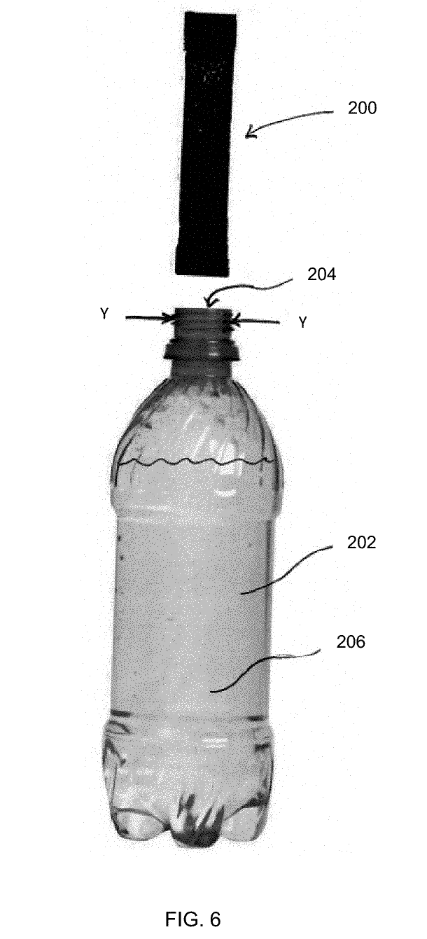

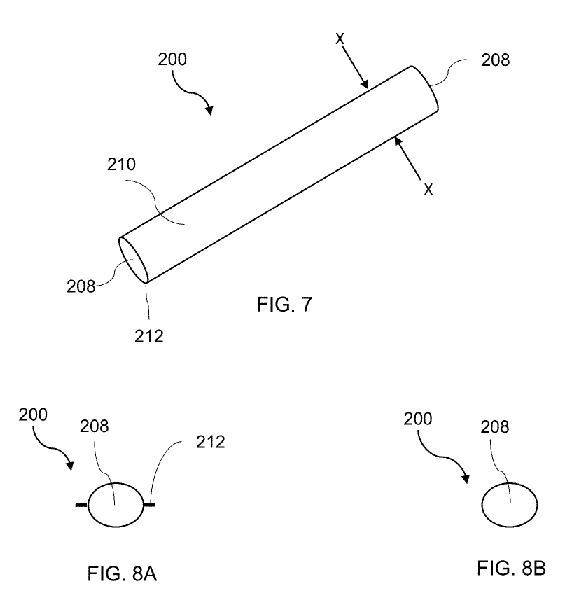

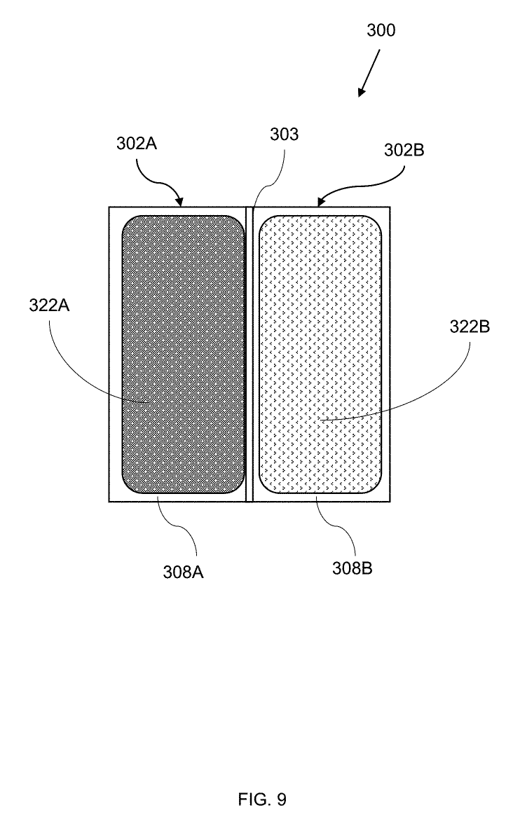

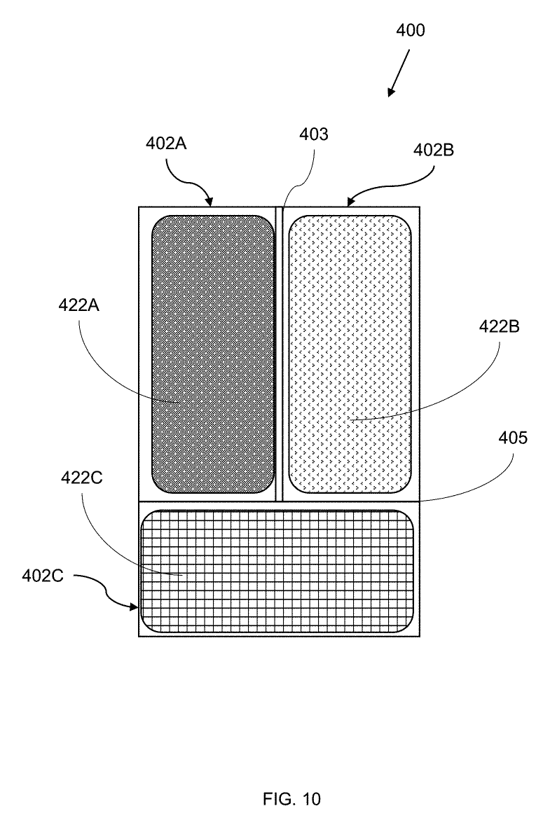

FIGS. 6-8B illustrate a further embodiment of an edible pod 200 shown in a tube/cylindrical configuration. The pod 200 defines an elongated shape having a length that is greater than a diameter. In this example, the diameter X of pod 200 is sufficiently smaller than a diameter Y wherein the diameter Y is a diameter of an opening 203 of a typical water bottle 202. The diameter Y of an opening 204 is approximately 1 inch. However, other exemplary water bottle may have an opening as small as ¾ inch or up to 1.5 inches or larger. Regardless, the tube 200 defines an outer diameter of less than Y shown by diameter X. In this example, the diameter X may range between 0.5-1.5 inches. However, in a preferred embodiments, the diameter X of the pod 200 will be just less than about 1 inch.

In this example, pod 200 includes an outer barrel portion 210 forming an exterior body. The outer barrel portion forms a generally cylindrical body wherein the tube shape is formed. A pair of end portions 208 are also provided defining a generally circular cross section. The end portions, may be smooth or include the joint portion 212 where the outer barrel portion 210 comes together.

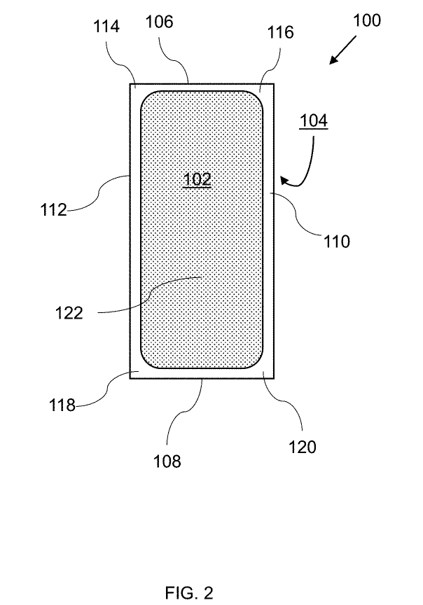

The outer barrel portion 210 and the end portions 208 are formed of a dissolvable film comprised of food grade ingredients that dissolve quickly in hot or cold water. Single servings of edible material, such as protein powder, are wrapped in the film to form the pod. When the film from the pod dissolves in the water, then the supplement is free to mix with the water to create a nutritional beverage designed for post workouts. In an example, the pod dissolves in under 10 seconds when shaken and blended in a water based solution. This includes complete dissolving of the enclosing film. The film should enclose the powder and form an airtight seal by way of a seam surrounding all the way around the pod as shown in FIG. 2.

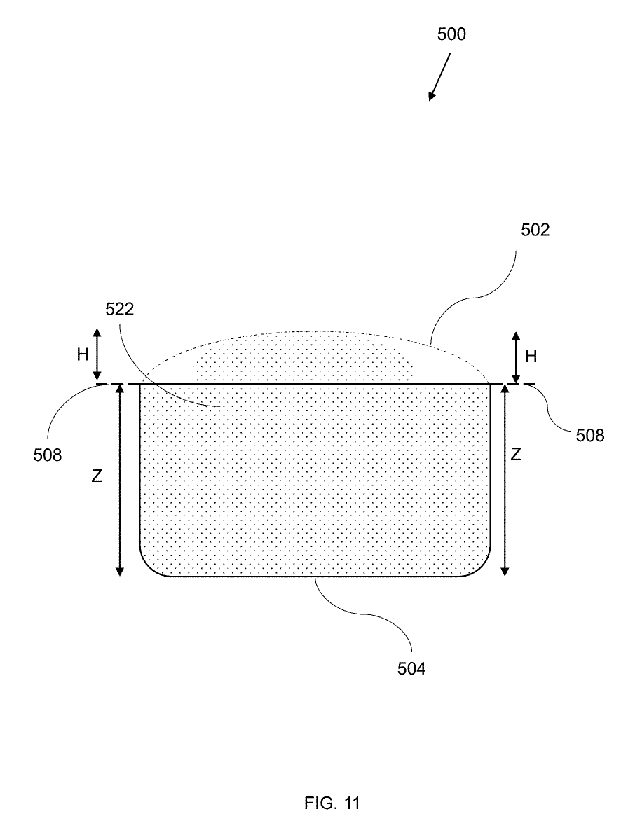

Referring to FIG. 9, a further exemplary embodiment of an edible pod 300 is shown. In this example, pod 300 includes a dual sectioned configuration separated by a sealed seam 303. First sectioned chamber 302A can include a first desired substance 322A and second sectioned chamber 302B can include a second desired substance 322B. The sections can be separated during production by a shared seam 303 which form a continuous boarder with seam 308A and 308B respectively. Just as previous embodiments, a desired substance, such as an edible powder is provided in each of chamber 302A and 302B which are then enclosed and sealed by a dissolvable and edible film. Having a dual chamber configuration allows for added freshness prior to mixing and dissolving in a liquid. For example, substance 322A can be a desired protein powder while substance 322B can be a flavoring agent or nutritional agent such as vitamins and/or electrolyte substance. Example flavoring agents include but are not limited to chocolate, vanilla, strawberry, among others. In another example, the substance 322A is a cocoa and the flavoring agent 322B is any desired accompanying component such as marshmallow, caramel, among others.

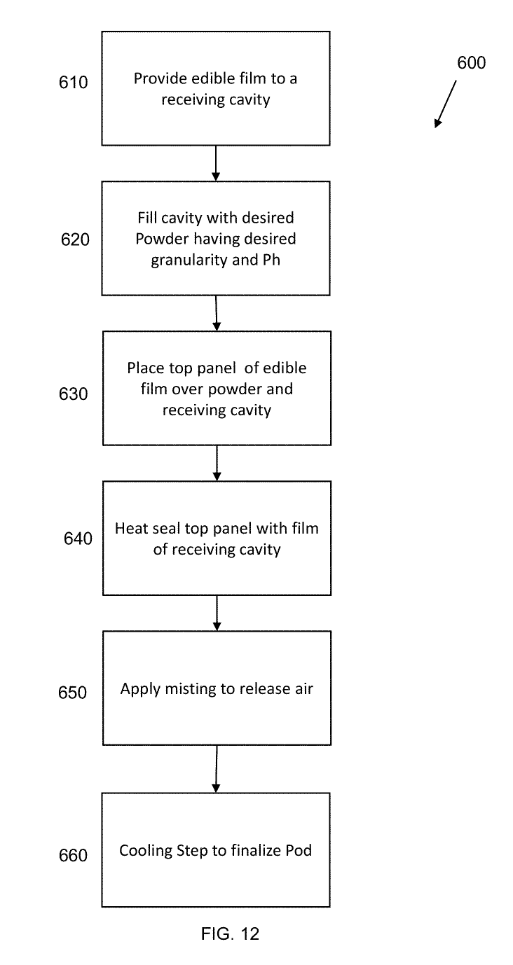

FIG. 10 illustrates an even further embodiment having a plurality of sealed off chambers for enclosing and holding a desired substance. In this example, a three-chambered pod 400 includes a first section 402A, a second section 402B, and a third section 402C. Similar to the features of pod 300 from FIG. 9, the three sections of pod 400 are separated and sealed off from one another via a seam 403 and 405. In this example, each chamber 402A, 402B, and 402C, is provided with a different edible substance 422A, 422B, and 422C respectively. The edible substances can be selected to complement each other when dissolved in a desired beverage. For example, substance 422A can be a protein powder, substance 422B can be a flavoring agent such as chocolate or vanilla, and substance 422C can be a vitamin, nutritional supplement, and/or electrolyte substance. The three chambers are enclosed and sealed with a dissolvable and edible film formed continuously and separated by the seams 403 and 405.

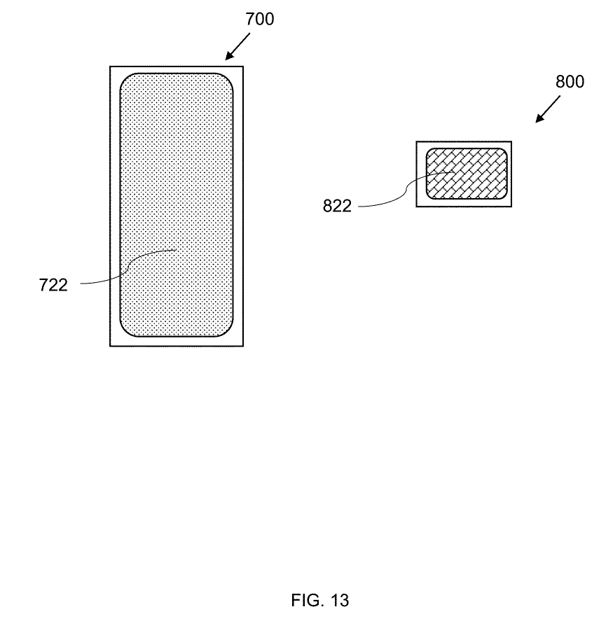

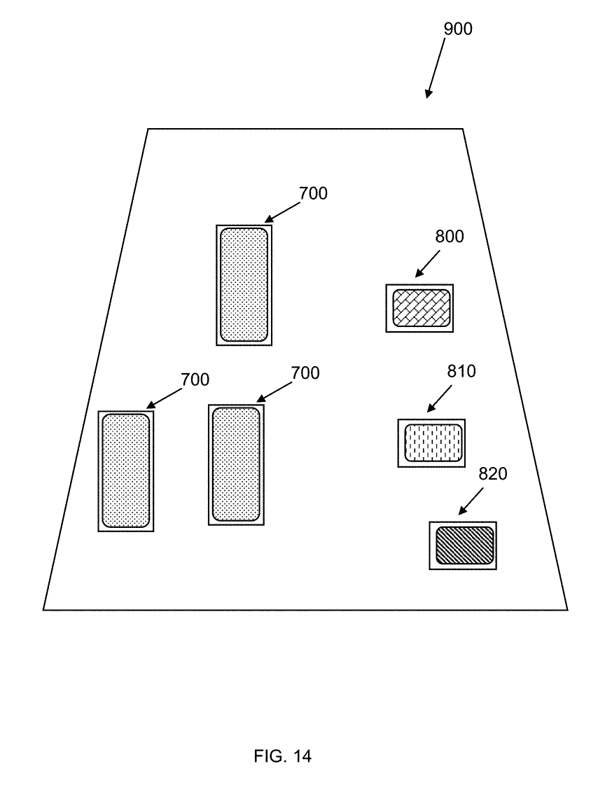

FIG. 11 illustrates a cross section view of a further example of an edible and dissolvable pod 500 according to the present disclosure. In this example, pod 500 includes a Top panel 502 formed of a dissolvable and edible film sealed with a cavity panel 504. Top panel 502 and cavity panel 504 enclose an edible substance 522, such as protein powder and the like. In this example, cavity panel 504 which defines a recess for receiving a powder during production and manufacturing. FIG. 12 illustrates a flow diagram of an example method 600 of forming an edible panel according to the present disclosure. According to method 600, pod 500 is formed by placing a film cavity panel 504 into a mold as shown in step 610, then adding a desired amount of substance 522 as shown in step 620. In step 620, a single serving of powder suitable for dissolving in a twelve ounce beverage is typically provided, followed by overlaying the top panel 502 as shown in step 630 and forming a seal 508 along a periphery of a joint formed by panels 502 and 504 as shown in step 640. Panel 502 seals over and around the substance 522 defining a height H. The pod 500 is formed such that height H is shallower than a depth Z defined by cavity panel 504 such that Z is always greater than H. This configuration allows for improved processing and more durable pods filled with sufficient serving size of the desired substance.

The process 600 for forming a dissolvable pod 500 can further include a misting process as shown in step 650 to further shrink the edible film during processing for more effective single serving packing. Accordingly, in one example, following the sealing process to form seams 508 and seal panels 502 and 504 together to enclose substance 522, a misting is applied to at least panel 502 which forms tiny holes in the film thus allowing air to escape the interior cavity and form a tighter fit around the loose powder 522. The misting process can be a heated water-based mixture that is misted in tiny droplets to form holes in the film. In an example, the misting mixture includes water and glycerin. The mixture can include a ratio of about 90% water and about 10% glycerin, but adjusted for different times of the year due to changes in temperature and humidity levels should be considered. This misting step is followed by a cooling step 660 which allows the film to seal together again eliminating the holes generating by the misting step. Cooling can include any process that allows the pods to return to room temperature. In this example, the cooling step includes air cooling. The result is an improved edible pod that includes a loose edible powder enclosed in a dissolvable and edible film with reduced air trapped within the enclosure. In an example, the misting process is a water-based process.

In yet another embodiment of the present disclosure, a plurality of pods according to the present disclosure are provided and packaged together. Since each pod is sealed with respect to any other pod packaged with it, multi-flavor packages can be made. This overcomes limitations by the existing edible and dissolvable powder market. Accordingly, the present disclosure provides for a packaging (e.g., bag, container, etc.) which includes a plurality of single serve edible and dissolvable pods having at least one pod flavor or substance different from another of the same packaging.

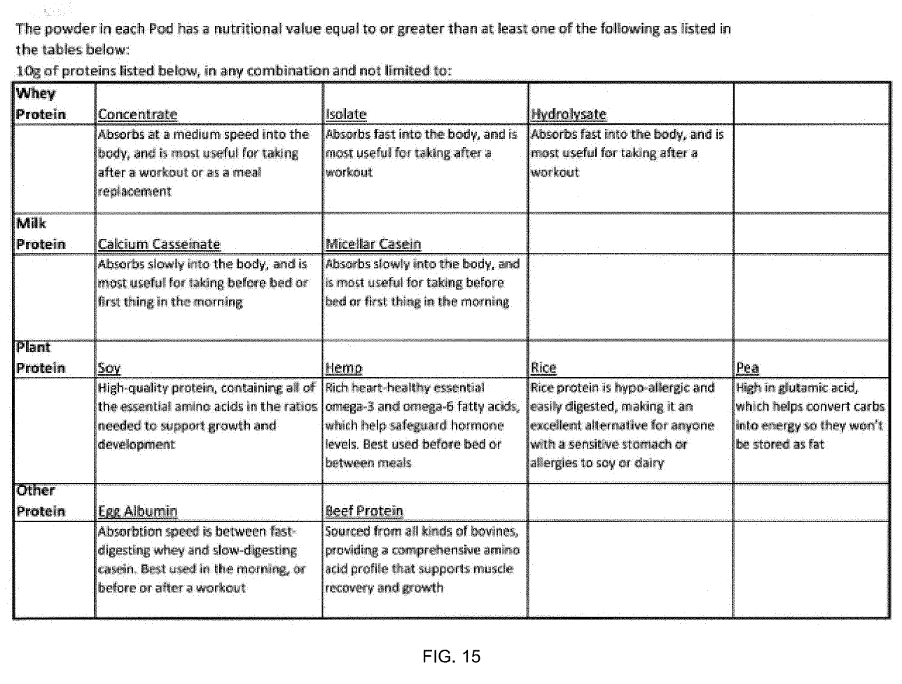

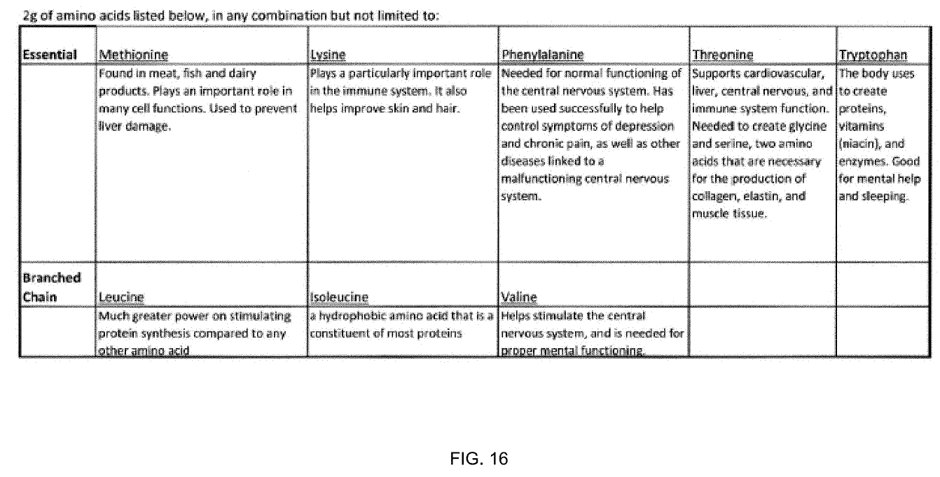

Referring to FIGS. 13-14, a dissolvable and edible pod system is shown according to the present disclosure. The system includes a first pod 700 similar to any of the pods described hereinabove. First pod 700 includes a substance 722 in powder form, for example a protein powder. The system further includes a second pod 800 which includes at least one flavoring agent 822. The second pod 800 is substantially smaller than the first pod 700. Accordingly, the first pod 700 can include “plain” protein powder which is substantially flavorless. The second pod 800 can include a variety of flavors to allow a user to selectively choose which flavor to use when combining with a liquid to make a beverage. A variety pack 900 can include a plurality of first pods 700 along with a plurality of different second flavoring pods 800, 810, and 820. In this example, each of the second flavoring pods 800, 810, 820 include a different flavoring agent relative to each other. For example, pod 800 can be chocolate, pod 810 can be vanilla, and pod 820 can be strawberry. Variety pack 900 can be any sufficient container for holding all of the pods including a plastic or paper bag or a canister made of plastic or metal, or any other like material. A variety of packaging options are within the scope of the present disclosure.

The dissolvable and edible film may be made from a variety of different suitable materials. These materials may be flavorless and calorie free. In another example, the film can include a flavoring and/or nutritional agent that mixes with the powder upon dissolving. The films may be made from sugar or sugar substitute materials, gelatin, plasticizers or other non-food based materials such as various polymers. The polymer employed should be non-toxic, non-irritant and devoid of leachable impurities. It should have good wetting and spreadability property. The polymer should exhibit sufficient peel, shear and tensile strengths. The material may include various stabilizing and thickening agents employed to improve the viscosity and consistency of dispersion or solution of the film. The film should be food grade quality and processed and meant to be consumed only after being dissolved in a liquid or water-based solution. Suitable polymers include edible grade polyvinyl alcohol among others. The film should be made to be relatively flexible, malleable and stretchable. In an example, the film defines a thickness of about 1 to 3 millimeters. The film can also be made to be colorless and clear. In a further example, the film can further include printed designs or logos. The design can be printed on the top panel and/or both panels. In another example, the printing on either panel occurs after the entire pod is constructed.

In an example, the desired edible substance may be any powder and/or granule type material. The pods disclosed hereinabove include powder provided in a relatively dry loose form. Thus, no deliberate binder is provided to solidify or further contain or hold the powder together. Loose powder allows for more efficient and desired dissolving and mixing with liquid upon use. Moreover, ease of manufacturing is improved along with costs since a binding agent is no longer necessary.

In another example, the powder includes supplement having nutritional ingredients for a human body. The supplement, commonly known as a protein powder, is used frequently with athletes, bodybuilders and weightlifters and may contain a variety and/or a combination of various ingredients. These supplements may include proteins, amino acids, fatty acids, meal replacement products and/or any other suitable nutritional supplement. The powder is usually mixed with water, milk or juice and is generally consumed immediately before and after exercising, or in place of a meal. The sources of protein may include, but are not limited to the following, and differ in protein quality depending on their amino acid profile and digestibility: whey protein, casein protein (or milk protein), soy protein, egg white protein, hemp protein, rice protein and/or pea protein.

In one example, the powder is provided having a limited pH range. The pH range of the powder should be sufficient to avoid degradation of the selected edible film which may occur with some powders. In one form of the present disclosure, the powder defines a pH range from about 4 to 10. In yet another form, the pH range of the powder is from about 5.5-8.5.

It is also be desired to have an effective granularity of the powder. Having proper granularity can improve serving size consistency among a plurality of pods. In one form, the pods are provided in a packaging or container such as a bag with a plurality of other single serving pods wherein each of the pods define a granularity sufficient to reduce variation among the plurality of pods to less than 5% by weight. In another form of the present disclosure, the powder may be a drink mix, flavor, sugar, sugar substitute or other mixable material used to mix with water or other water based beverages. Granularity can be measured according to a Hausner ratio of 1-1.45 and/or angle of response of about 25-55. According to Table 1 below, certain parameters outlined define flow properties ranging from poor to Excellent according to publication to Lumay et al. titled Measuring the flowing properties of powders and grains, Powder Technology 224 (2012) 19-27. In an example, the granularity of a powder provided in a pod according to the present disclosure defines a Hausner ratio of between 1-1.25.

| Flow property | Angle of repose (*) | Hausner ratio |
|---|---|---|
| Excellent | 25-30 | 1.00-1.11 |
| Good | 31-35 | 1.12-1.18 |
| Fair | 36-40 | 1.19-1.25 |
| Passable | 41-45 | 1.26-1.34 |
| Poor | 46-55 | 1.35-1.45 |

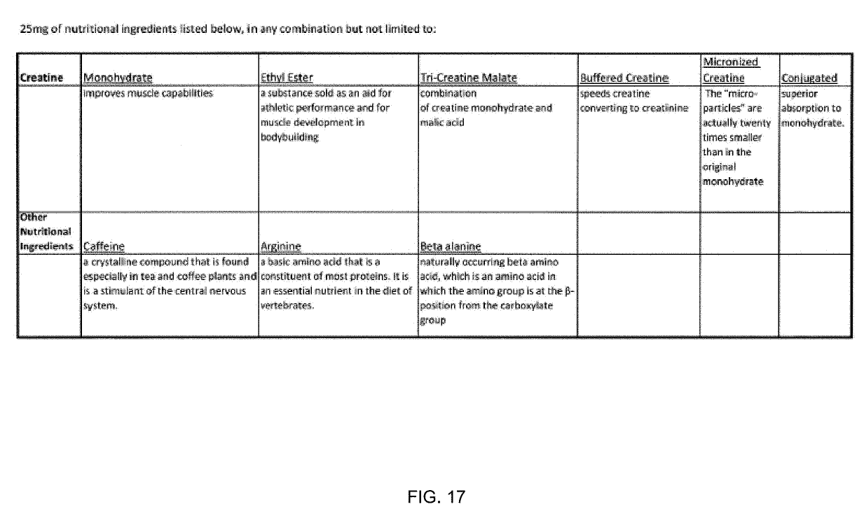

A single serving of powder, in particular, a nutritional protein powder can be provided with a predetermined calorie content along with a predetermined protein quantity. This serving size should be sufficient to fully dissolve and mix with a predetermined volume of liquid, for example water, juice, milk, etc. In an example, a single serving can contain 90 calories, 20 grams of protein and sufficient to dissolve in 8 oz to 20 oz of liquid. Often, single servings of liquid are from 12 oz to 20 oz. Depending on what substances are chosen, the total serving size of each edible pod can vary. For example, chocolate flavored isolated whey can provide 24.6 grams/serving with 20 grams of protein while vanilla flavor can provide 23 grams/serving with 20 grams of protein. FIGS. 15-17 provide charts illustrating various combinations of nutritional specifications of a powder which can be provided within the pods of the present disclosure.

The single serving pods of the present disclosure allow for a user to selectively carry one or more pods rather than an entire container (e.g., large canister or bag) of powder. Thus, this allows for user flexibility in grabbing only a single serving on the go when headed for a workout. There is no need to carry the entire jar or container of supplement powder. In this example, the portions are premeasured so the user is provided with the proper amount of supplement powder without having to use a scoop or other measuring device. The pods help reduce mess and general user handling since there is no transfer of the supplement from a container to the bottle.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An edible and dissolvable pod comprising:
(a) an edible and dissolvable substance provided in a loose powder form;
(b) an edible and dissolvable enclosure fully enclosing the edible and dissolvable substance, the enclosure having:
(i) a lower panel forming a receiving cavity defining a depth Z, wherein the edible and dissolvable substance is provided in the receiving cavity;
(ii) an upper panel positioned over the substance provided in the receiving cavity of the lower panel, the upper panel defining a height H;
(iii) an outer seam forming a seal between the upper and lower panel;
wherein the edible and dissolvable substance is provided in a predetermined quantity sufficient to dissolve in a predetermined volume of liquid;
wherein the substance defines a pH range sufficient to prevent degradation of the film and
wherein the depth Z of the lower panel is greater than height H of the upper panel.

2. The edible and dissolvable pod according to claim 1, wherein the edible and dissolvable substance includes a protein powder.

3. The edible and dissolvable pod according to claim 2, wherein the protein powder includes at least 20 grams of protein.

4. The dissolvable pod according to claim 2, wherein the predetermined quantity of edible and dissolvable substance is provided in a serving size having a mass of about 10 grams to 50 grams.

5. The edible and dissolvable pod according to claim 2, wherein the predetermined quantity of edible and dissolvable substance is provided in a serving size having a mass of about 20 grams to 30 grams.

6. The edible and dissolvable pod according to claim 1, wherein the film defines a thickness from 1 to 3 millimeters.

7. The edible and dissolvable pod according to claim 1, wherein the film includes a printed design on at least one of the upper and lower panel.

8. The edible and dissolvable pod according to claim 1, wherein the predetermined volume of liquid is between 8 ounces and 20 ounces and the pod is formed to dissolve in hot or cold liquid in less than 10 seconds.

9. The edible and dissolvable pod according to claim 1, wherein the depth Z is greater than twice the length of height H.

10. The edible and dissolvable pod according to claim 1, further comprising a plurality of chambers connected to adjacent chambers via a sealed seam and physically separated with respect to a substance provided in the chamber.

11. The edible and dissolvable pod according to claim 10, further comprising a first chamber and at least a second chamber, and further comprising a second edible and dissolvable substance provided in the second chamber, wherein the second substance is different from a substance in the first chamber.

12. The edible and dissolvable pod according to claim 11, wherein the substance in the first chamber is a protein powder and the second substance is a flavoring agent provided in powder form and suitable for mixing with the protein powder when dissolved in a liquid.

13. The edible and dissolvable pod according to claim 1, wherein the substance defines a pH range from about 4 to 10.

14. The edible and dissolvable pod according to claim 1, wherein the substance defines a pH range from about 5.5 to 8.5.

15. The edible and dissolvable pod according to claim 1, wherein the powder provided in the enclosure defines a Hausner ratio of between 1-1.25.

16. The edible and dissolvable pod according to claim 1, wherein the pod is a single serving of protein powder including 20 grams of protein and has a calorie content of about 90 calories, and wherein the pod is operable to fully dissolve in a liquid having a volume of 8 oz to 20 oz.

17. A variety pack of edible and dissolvable pods comprising a plurality of individual pods according to claim 1; wherein each pod is sealed off with respect to other pods in the pack and wherein at least two of the pods have different substances.

18. A method of making the pod of claim 1, the method comprising:
(a) providing an edible and dissolvable film as a lower panel into a receiving cavity;
(b) filling the cavity with a powder substance that is edible and dissolvable;
(c) placing a dissolvable and edible upper panel film over the powder provided in the cavity;
(d) heat sealing the upper panel to the lower panel along a peripheral seam;
(e) applying a misting operable to generate air release holes in the upper panel thereby releasing air; and
(f) cooling the pod to form an airtight seal enclosure formed by the upper and lower panels and the seam.

19. An edible and dissolvable pod system comprising:
(a) a first pod having an edible and dissolvable substance provided in a loose powder form fully enclosed by an edible and dissolvable enclosure film having a lower panel forming a receiving cavity defining a depth Z, wherein the edible and dissolvable substance is provided in the receiving cavity, an upper panel positioned over the substance provided in the receiving cavity of the lower panel, the upper panel defining a height H, and an outer seam forming a seal between the upper and lower panel;
(b) a second pod having an edible and dissolvable flavoring agent enclosed in an edible and dissolvable film, the second pod defining a mass smaller than a mass of the first pod;
wherein the flavoring agent is selected to compliment the substance of the first pod;
wherein the first and second pod are provided in predetermined quantities sufficient to dissolve in a predetermined volume of liquid together; and
wherein the depth Z of the lower panel is greater than height H of the upper panel.

20. A variety pack of first pods and second pods according to claim 19; wherein a plurality of different flavored second pods are provided and each of the first and second pods is sealed off with respect to other pods in the pack.
